(19) United States
(12) Patent Application Publication
(10) Pub. No.: US 2013/0130780 A1
(43) Pub. Date: May 23, 2013

(54) EVENT ACTIVATION RELATED TO WAGERING GAME PLAY

(71) Applicants: Jeffrey L. Allen, Naperville, IL (US); Andrew C. Guinn, Chicago, IL (US); Travis N. Nelson, Canton, GA (US); Richard B. Robbins, Glenview, IL (US); Pamela S. Smith, Chicago, IL (US)

(72) Inventors: Jeffrey L. Allen, Naperville, IL (US); Andrew C. Guinn, Chicago, IL (US); Travis N. Nelson, Canton, GA (US); Richard B. Robbins, Glenview, IL (US); Pamela S. Smith, Chicago, IL (US)

(73) Assignee: WMS Gaming, Inc., Waukegan, IL (US)

(21) Appl. No.: 13/546,167

(22) Filed: Jul. 11, 2012

Related U.S. Application Data
(60) Provisional application No. 61/506,535, filed on Jul. 11, 2011.

(51) Int. Cl. G07F 17/32; A63F 13/10

(52) U.S. Cl. CPC G07F 17/3244
USPC 463/25

(57) ABSTRACT

A method includes creating an event related to a wagering game, wherein the creating of the event comprises setting a requirement for the event. The requirement includes at least one of a participatory requirement and a monetary requirement for activation of the event. The participatory requirement includes a minimum number of wagering game players required to elect participation in the event. The creating of the event also includes defining an added value wagering game activity for the wagering game players that have elected participation in the event. The added value wagering game activity comprising at least one of access of locked content of the wagering game, increased expected value for payout from the wagering game, increased value of a jackpot of the wagering game, access to a locked progressive jackpot, and access to locked bonuses.

### RELATED APPLICATIONS

This application claims the priority benefit of U.S. Provisional Application Ser. No. 61/506,535 filed Jul. 11, 2011

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011, WMS Gaming, Inc.

### FIELD

Embodiments of the inventive subject matter relate generally to wagering game systems, and more particularly to wagering game systems including wagering game play event activation.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 depicts a system for providing activation events related to wagering game play base on at least one of participation of players, monetary amount and player points, according to some example embodiments.

FIG. 2 depicts the system of FIG. 1, wherein only players wagering at a wagering game machine at a wagering game establishments are invited to participate in the event, according to some example embodiments.

FIG. 3 depicts the system of FIG. 1, wherein only one player is invited to participate in the event, according to some example embodiments.

FIGS. 4-5 depict flowcharts for providing activation events related to wagering game play base on at least one of participation of players, monetary amount and player points, according to some example embodiments.

FIGS. 6-7 depict flowcharts for providing event activation related to wagering game play and having accessible content based on discounted monetary amount, according to some example embodiments.

FIG. 8 depicts a block diagram illustrating a wagering game machine architecture, according to some example embodiments.

FIG. 9 depicts a block diagram illustrating a wagering game network, according to some example embodiments.

FIG. 10 depicts a perspective view of a wagering game machine, according to some example embodiments.

### DESCRIPTION OF THE EMBODIMENTS

This description of the embodiments is divided into six sections. The first section provides an introduction to some example embodiments, while the second section provides various system environments. The third section describes example operations performed by some example embodiments and the fourth section describes an example wagering game machine architecture and network environment. The fifth section describes an example wagering game machine and the sixth section presents some general comments.

### INTRODUCTION

This section provides an introduction to some example embodiments.

Some example embodiments provide an event related to wagering game play, wherein the event includes one or more of the following: 1) scarcity of participation, 2) threshold requirements to activate, and 3) an added value activity for participation. Some example embodiments can be applicable to wagering game play at a brick-and-mortar wagering game establishment (e.g., a casino) and an online wagering game web site. Also, some example embodiments can be applicable to wagering game play of wagering game machines (e.g., slot machines, video poker, etc.) and table games (e.g., blackjack, roulette, poker, etc.). Also, some example embodiments can be applicable to mobile devices. For example, these mobile devices can be used for wagering game play at a brick-and-mortar wagering game establishment and for wagering game play at online wagering game web sites.

Threshold requirements to activate an event can include one or more of a participatory requirement, a monetary requirement, and a player account points requirement. In particular, some example embodiments can require a threshold (e.g., a participatory threshold, a monetary expenditure threshold, points expenditure threshold, etc.) to trigger an event that provides an added value activity for wagering game play. For example, the player can be required to contribute X amount of money, Y amount of points to participate in the event, while at least N number of players are required to participate to activate the event. Example of an added value activity for a wagering game (e.g., a slot game) can include unlocking of content, unlocking of an individual bonus, unlocking of a progressive jackpot, increasing of expected values, increasing the payout of the top prize, unlocking a community game, etc. that are part of a wagering game.

Some example embodiments provide scarcity and exclusivity aspects with regard to triggering the event. For example, only first 50 players that elect participation are allowed to participate in this event. In some example embodiments, incentives to participate in such a wagering game activity can include a reduced cost to play. The offers to participate in an event can have a time limit (e.g., 2 hours) and/or participation limit (e.g., only 10 players). In some example embodiments, players that elect to participate earlier than other players that have elected to participate receive a greater benefit (e.g., better pay tables, bigger top prize, etc.).

Some example embodiments incorporate points from one or more player accounts for wagering game activity. In particular, points can be awarded to a player as a part of one or more player accounts associated with wagering game play. Points can be awarded for different types and amounts of game play. For example, there can be an online player account for non-wagering game activity that can be related to wagering game play at the wagering game establishments, a different player account that can be specific to a wagering game establishment or group of wagering game establishments, a different player account for wagering game play at an online wagering game website, etc. In some example embodiments, some or all of these player accounts can be integrated into a same player account. These points from these player accounts can be used to participate in an event (as described herein). In some example embodiments, the activity can be unlocking content, a progressive bonus, etc. on a wagering game machine. The players can be required to pool a number of points to access the activity.

Players can be notified of an event through one or more of their player accounts accessible at the wagering game establishment, online, etc. Alternatively or in addition, players can be notified of an activity by emails, text messages, telephone calls, etc. The notifications to the player can indicate how close the threshold is in order to trigger the event. In some example embodiments for a wagering game establishment, only players that are in the wagering game establishment are notified. Alternatively or in addition, only players that are logged into their account either at the wagering establishment or the wagering game website are notified.

There can also be eligibility requirements for players that are invited to an event. The participatory requirement can include a requirement for the type of players that are eligible. For example, players that spend X number of dollars for a given time period would be eligible to participate. In some example embodiments, only the players that are playing a specific wagering game are eligible. For example, for a wagering game establishment, only the players that are logged into their account at a wagering game machine of a bank of wagering game machines are eligible for participating in an activity. Also, a certain number of the eligible players are required to participate in the event to activate. For example, all players at a bank of wagering game machines can be required to participate in order to activate the event. In some example embodiments, players are required to pay a certain monetary amount to participate. If the number of players required to participate does not exceed the required threshold, the players that have elected to participate can be given the option to pay an additional monetary amount to activate the event (even though the requisite number of players electing to participate was not met).

The event can provide for various added value wagering game activities. Example of an added value activity for a wagering game (e.g., a slot game) can include unlocking of content, unlocking of an individual bonus, unlocking of a progressive jackpot, increasing of expected values, increasing the payout of the top prize, unlocking a community game, etc. that are part of a wagering game. For example, for a slot game, the added value activity can provide an extra spin where the pay tables are adjusted for better pay out, a bigger top prize, etc. For a bingo game, the added value activity can include a bingo card that has extra numbers that are already covered which are required to be called to win the game.

Examples of added value activities can also include receiving N number of free spins, N number of free spins with a 3× multiplier, etc. In some example embodiments, the added value activities are not related to wagering games. For example, some or all of the participants players can also receive a free dinner, 5 minutes in a free cash grab glass container within the wagering game establishment, etc. The added value wagering game activity can be short term (e.g., one-half hour) or long term (e.g., six month). Other examples of added value activities are set forth below.

In another type of event, a coupon or award is given to a wagering game player after the wagering game player has played a number of a same game or different games within a specific time frame. For example, a wagering game player can receive a coupon or award after they have played six unique jungle-themed slot games within three hours.

In some example embodiments, there is an integration between wagering game play at a brick-and-mortar wagering game establishment and wagering game play at an online wagering game web site. For example, a coupon can be awarded for wagering game play at the online wagering game web site and then for wagering game play at a brick-and-mortar wagering game establishment or vice versa. To illustrate, a wagering game player can be awarded a coupon after playing $20 on a slot game having theme X on the online wagering game web site and then playing $20 on a slot game also having theme X at a brick-and-mortar wagering game establishment.

In some example embodiments, the event is associated with a table wagering game. For example, to participate, players can pay an additional monetary amount for a blackjack table game. Because of their participation, these players play from a special set of cards. For example, these participating players would play from a two-deck shoot instead of a typical six-deck shoot for blackjack. To activate this event a percentage of the tables can be required to be filled for a given time period. For example, if all tables are 100% filled for the next hour, then the event is activated to allow for the use of these special set of cards for a 30 minute session. In another example event for a table game, the activity can guarantee a lower minimum bet. For example, as part of eligibility, participating players can pre-pay prior to arrival at the wagering game establishment. In return, the participating players are allowed to play at a blackjack table with $5 minimum bet. In another example event, the table game can be roulette, wherein the activity includes a limited session where multiple (e.g., two) balls instead of one are played.

Some example embodiments provide a greater incentive to join the event early. In particular, participating players that elect to join the event earlier than other players can receive a greater award. In some example embodiments, these events can be offered to potential players as part of booking of their trip to the city having the wagering game establishment. Accordingly, the players can pre-pay for such events as part of a package deal and can participate in the events upon arrival.

### System Environment

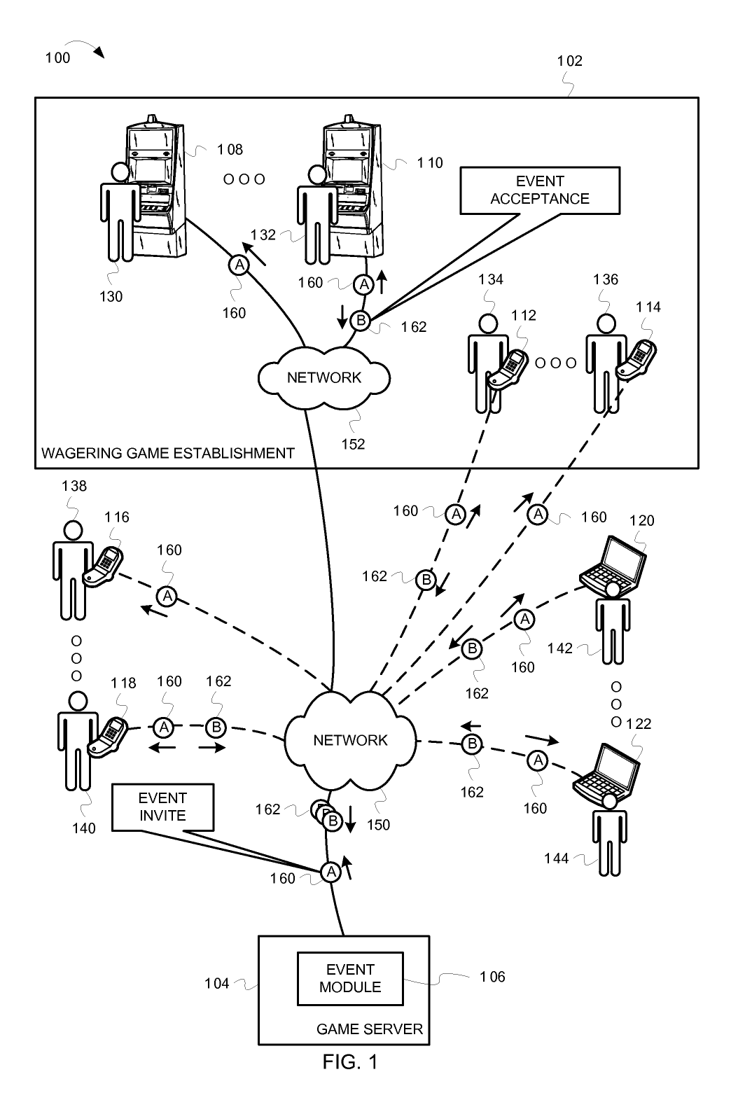

This section describes example system environments and presents structural aspects of some embodiments. This section includes example systems for activation of events related to wagering game play. This section will discuss FIGS. 1-3

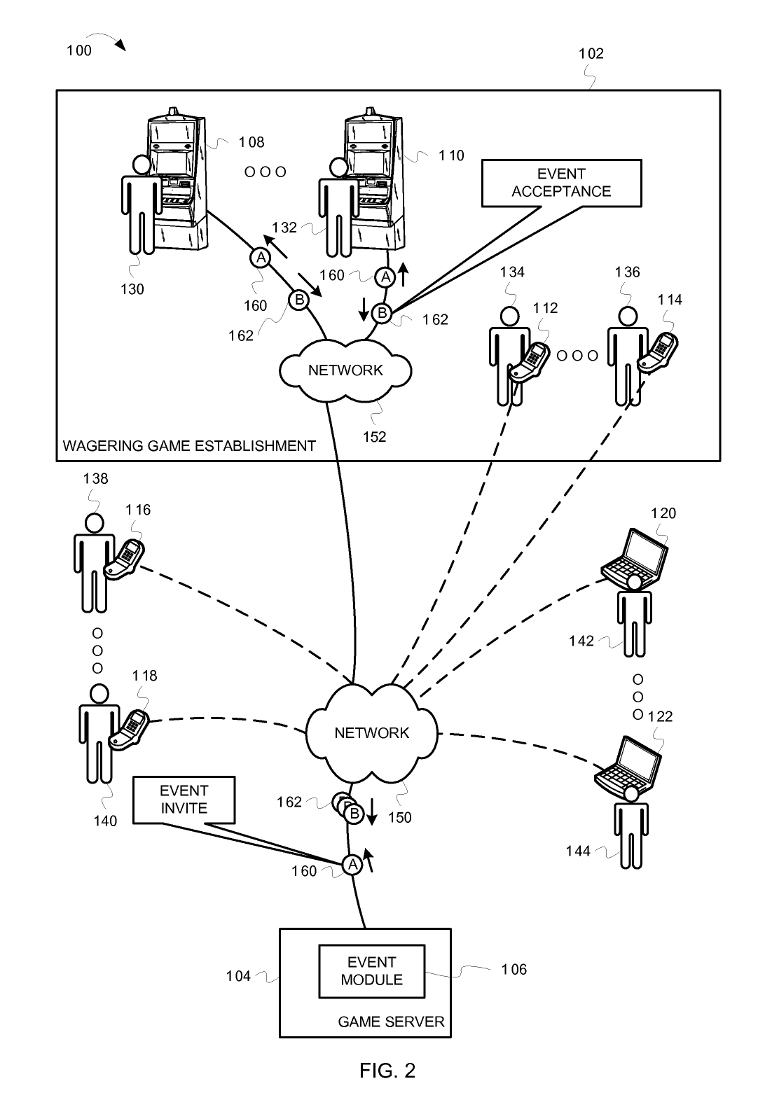

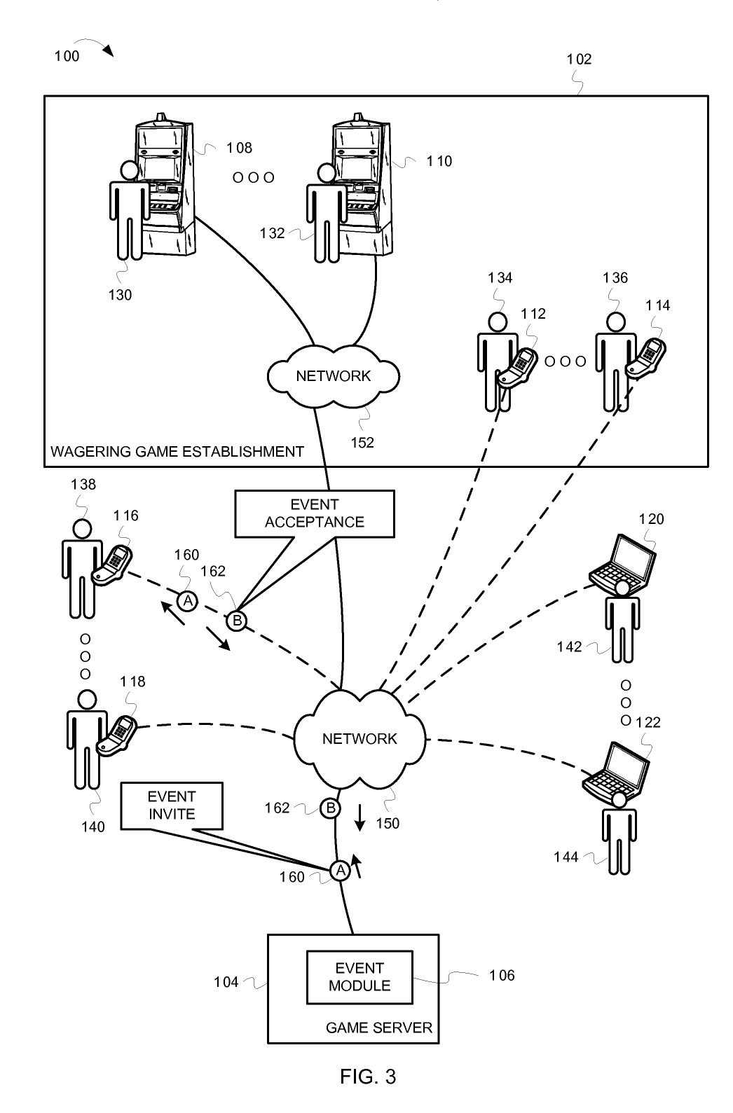

The discussion of FIG. 1 will describe a system that provides activation events related to wagering game play base on at least one of participation of players, monetary amount and player points. The discussion of FIG. 2 will describe the system of FIG. 1 wherein a subset of the wagering game players receives an event invite. The discussion of FIG. 3 will describe the system of FIG. 1 wherein one wagering game player receives an event invite.

FIG. 1 depicts a system for providing activation events related to wagering game play base on at least one of participation of players, monetary amount and player points, according to some example embodiments. FIG. 1 depicts a system 100 that includes a game server 104 that includes an event module 106. The event module 106 can be software, firmware, hardware or a combination thereof. For example, the event module 106 can be software that is loaded into a processor for execution therein. As further described below, the event module 106 can create events related to wagering game play. The event module 106 can also transmit invitations to one or more wagering game players to participate in the events. The event module 106 can receive acceptance by the wagering game players to participate in the events and can activate the events at different devices that provide for wagering game play.

The game server 104 is communicatively coupled to various devices which wagering game players use. The game server 104 is communicatively coupled to a network 150. The system 100 includes a wagering game establishment 102 that includes a number of wagering game machines (shown as a wagering game machine 108 through a wagering game machine 110). A wagering game player 130 is wagering on the wagering game machine 108, and a wagering game player 132 is wagering on the wagering game machine 110. The wagering game establishment 102 includes a network 152 that is communicatively coupled to the network 150. The game server 104 is communicatively coupled to the wagering game machine 108 and the wagering game machine 110 through the network 150 and the network 152.

In some example embodiments, the event module 106 can communicate with wagering game players even though they are not currently wagering at a wagering game machine in a wagering game establishment. For example, wagering game players can be on devices that allow them to access their online wagering game account, their non-wagering game account, etc. In this example, these wagering game players are shown as a wagering game player 142 through a wagering game player 144. The wagering game player 142 is using a computer 120, and the wagering game player 144 is using the computer 122. For example, the wagering game player 142 can be logged into their player account for online wagering game play; while the wagering game player 144 can be logged into a different type of player account that is non-wagering but is related to wagering game activities.

The event module 106 can also communicate with wagering game players through their mobile devices. In this example, the system 100 illustrates wagering game players using mobile devices internal or external to the wagering game establishment 102. These different mobile devices used by wagering game players are communicatively coupled to the game server 104 through the network 150. The different mobile devices may or may not be used for wagering game play. In these examples, the event module 106 can communicate event notifications to these mobile devices through emails, text messages, telephone calls, etc. In this example, the different mobile devices external to the wagering game establishment 102 are represented by a mobile device 116 through a mobile device 118. A wagering game player 138 is using the mobile device 116, and a wagering game player 140 is using the mobile device 118. The mobile devices 116-118 can be various distances from the wagering game establishment 102 (right outside, in a different city, in a different country, etc.). The different mobile devices internal to the wagering game establishment 102 are represented by a mobile device 112 through a mobile device 114. A wagering game player 134 is using the mobile device 112, and a wagering game player 136 is using the mobile device 114.

Accordingly, the event module 106 can invite wagering game players to an event through any of a number of devices (internal and external to the wagering game establishment 102)—the wagering game machines 108-110, the mobile devices 112-118, and the computers 120-122. In some example embodiments, the event module 106 can provide notification to the wagering game players through one or more of their player accounts. The player accounts can include a player account for wagering game play at the wagering game establishment 102, a player account at an online wagering game website, a player account for an online nonwagering game activity that can be related to wagering game play. Alternatively or in addition, the wagering game players can be notified of an event by emails, text messages, telephone calls, etc.

Some or all wagering game players can be notified of an event. In FIG. 1, all wagering game players are notified. FIGS. 2-3 provide examples wherein only some of the wagering game players are notified based one to any number of eligibility requirements (as further described below). In the system 100 of FIG. 1, the event module 106 transmits an event invite notification 160 (shown as a circle A in FIG. 1). The event module 106 transmits the event invite notification 160 to each of the wagering game players—the wagering game player 130 at the wagering game machine 108, the wagering game player 132 at the wagering game machine 110, the wagering game player 134 at the mobile device 112, the wagering game player 136 at the mobile device 114, the wagering game player 138 at the mobile device 116, the wagering game player 140 at the mobile device 118, the wagering game player 142 at the computer 120, and the wagering game player 144 at the computer 122.

In this example, some of the wagering game players have elected to participate—shown as transmission of event acceptance 162 (shown as a circle B in FIG. 1) from the devices back to the wagering game server 104. In particular, the wagering game player 132 has accepted to participate in the event using the wagering game machine 110; the wagering game player 134 has accepted to participate in the event using the mobile device 112; the wagering game player 140 has accepted to participate in the event using the mobile device 118; the wagering game player 142 has accepted to participate in the event using the computer 120; and the wagering game player 144 has accepted to participate in the event using the computer 122.

The event module 106 can create an event that includes at least one of the following: 1) scarcity of participation, 2) threshold requirements to activate, and 3) an added value activity for participation. Also, while described relative to wagering game machines (e.g., slot machines), some example embodiments can be incorporated into table games (e.g., blackjack, roulette, poker, etc.). The event module 106 can administer these events electronically to electronic table games. Alternatively or in addition, in wagering game establishments personnel can administer events for table games at traditional tables.

Activation of the event can include threshold requirements (including one or more of a participatory requirement, a monetary requirement, and a player account points requirement). In particular, some example embodiments can require a threshold (e.g., a participatory threshold, a monetary expenditure threshold, points expenditure threshold, etc.) to trigger an event that provides an added value activity for wagering game play. For example, the player can be required to contribute X amount of money, Y amount of points to participate in the event, while at least N number of players are required to participate to activate the event.

Participation in the event provides an added value activity for the wagering games. Examples of an added value activity for a wagering game (e.g., a slot game) can include unlocking of content, unlocking of an individual bonus, unlocking of a progressive jackpot, increasing of expected values, increasing the payout of the top prize, unlocking a community game, etc. that are part of a wagering game.

In some example embodiments, the event module 106 configures the event to provide scarcity and exclusivity aspects with regard to triggering the event. For example, only first 50 players that elect participation are allowed to participate in this event. In some example embodiments, incentives to participate in such a wagering game activity can include a reduced cost to play. The offers to participate in an event can have a time limit (e.g., 2 hours) and/or participation limit (e.g., only 10 players). In some example embodiments, players that elect to participate earlier than other players that have elected to participate receive a greater benefit (e.g., better pay tables, bigger top prize, etc.).

Some example embodiments incorporate points from one or more player accounts for wagering game activity. Accordingly, as part of acceptance to participation in the event, the event module 106 can require the player to commit a defined number of points from one or more of their player accounts. In particular, points can be awarded to a player as a part of one or more player accounts associated with wagering game play. Points can be awarded for different types and amounts of game play. For example, there can be an online player account for non-wagering game activity that can be related to wagering game play at the wagering game establishments, a different player account that can be specific to a wagering game establishment or group of wagering game establishments, a different player account for wagering game play at an online wagering game website, etc. In some example embodiments, some or all of these player accounts can be integrated into a same player account. These points from these player accounts can be used to participate in an event (as described herein). In some example embodiments, the activity can be unlocking content, a progressive bonus, etc. on a wagering game machine. The players can be required to pool a number of points to access the event.

The event module 106 can configure the event invite 160 to notify the wagering game players how close the threshold is in order to trigger the event. For example, assume that the event requires 10 wagering game players to participate. The event module 106 can provide multiple event invites for an event, wherein the event invites indicate how many more wagering game players are needed to participate to trigger the event.

The event module 106 can configure an event to provide for various added value wagering game activities. Example of an added value activity for a wagering game (e.g., a slot game) can include unlocking of content, unlocking of an individual bonus, unlocking of a progressive jackpot, increasing of expected values, increasing the payout of the top prize, unlocking a community game, etc. that are part of a wagering game. For example, for a slot game, the added value activity can provide an extra spin where the pay tables are adjusted for better pay out, a bigger top prize, etc. For a bingo game, the added value activity can include a bingo card that has extra numbers that are already covered which are required to be called to win the game.

Examples of added value wagering game activities can also include receiving N number of free spins, N number of free spins with a 3× multiplier, etc. In some example embodiments, the added value activities are not related to wagering games. For example, some or all of the participants players can also receive a free dinner, 5 minutes in a free cash grab glass container within the wagering game establishment, etc. The added value wagering game activity can be short term (e.g., one-half hour) or long term (e.g., six month).

In some example embodiments, the added value activity can include the acquisition of a range of spins for a progressive jackpot. For example, assume that a progressive jackpot can include a potential range of spins from 1-700. The player can acquire spins 400-450 of the progressive jackpot. If the progressive jackpot win occurs earlier than spins 400-450, the acquired spins would be much closer to the reset point. For example, assume that in this example, the progressive jackpot win occurred at spin 399. The acquired spins would carry over to the next progressive jackpot. Accordingly, the acquired spins would be spins 1-150 of the next progressive jackpot. The added value activity can also include the unlocking of every bonus for every wagering game for a given vendor across one or more wagering game establishments, all wagering games in a given wagering game establishment, etc. for a limited session.

Another added value activity can be access to a wagering game that is not generally accessible by players. Another added value activity can be a session wherein certain content, bonuses, etc. are unlocked for a given wagering game for a given time period. For example, the participating players can play a wagering game where all the bonuses are unlocked for the next two hours. Some example embodiments can determine the cost to a typical player for unlocking this content, bonuses, etc. during normal wagering game play. For example, assume it typically costs a player $150 to unlock a given episode in an episodic wagering game. As part of the notification of the activity, the player can be notified of this monetary amount. For example, as part of the notification to encourage a player to participate in an activity, the player is notified that they can unlock certain content (which typically costs $150 through normal wagering game play) for only $75. There can be a limited number of players that can participate. Also, the players can be notified while logged onto their player account at the wagering game establishment or wagering game website, through email, text message, voice call, etc. For example, the players are notified that they can participate in this event wherein they are allowed access to this content for one two-hour session that can be used at their conveniences over the next two weeks. Alternatively, the players who are logged into their player accounts can be required to participate in this event immediately. Such embodiments that unlock certain content gives the players a “taste” of the unlocked content to thereby incentivize them to play the wagering game through normal wagering game play to unlock the content after the activity is complete.

Another added value activity can be a session to play a downloadable wagering game at the wagering game establishment or a wagering game at the online wagering game website that was previously released but currently unavailable (“the classic” wagering games). These games can have increased top prizes, better expected values, larger bonuses, etc. in comparison to currently released wagering games.

Another added value activity can be an increased expected value, increased top prize, etc. for a given session. For example, a participating player can have a 1% increase in the expected value for a one-hour session. The eligibility of such an activity can require the participating player to wager a certain monetary amount as part of the wagering game play in the session. In other words, the player can be required to pre-pay or guarantee play of a given monetary amount.

After the requirements are met, the event module 106 can activate the event. For example, after N number of wagering game players have elected to participate and contribute X amount of money for participation, the event module can transmit communications to the player accounts and/or machines to activate the event. For example, if the event is to occur at the wagering game machine 108 and the wagering game machine 110, the event module 106 can transmit a message to activate the event to the wagering game machine 108 and the wagering game machine 110 (the message can include an identification of the event, the identification of the players that are participating, the length of the event, etc.). The event with the added value activity (e.g., a progressive jackpot) can be initiated at the wagering game machine 108 and the wagering game machine 110.

In some example embodiments, a list of potential features as part of the activity is provided to the participating players. The participating players can vote for the feature they desire. The feature with the most votes among the participating players becomes the feature for the activity. For example, the potential features can include a) increased top prize, b) increased expected value, c) unlock an episode, d) unlock a bonus, etc. The added value activity can also include some type of guaranteed win(s). For example, for video poker, among the group of participating players, at least one of the participating players is guaranteed to win a four of a kind, 10 full houses, one royal flush, etc.

In some example embodiments, the event module 106 can configure an event to provide a greater incentive to join the event early. In particular, participating players that elect to join the event earlier than other players can receive a greater award. For example, assume that event is a progressive jackpot as part of a wagering game. Players typically have a tendency to wait until the progressive jackpot is closer to the top end of the range for the jackpot (and closer to its reset) prior to entering. In particular, an expected value for a single spin for a progressive jackpot increases as the top end of the range of the jackpot is approached (even though the jackpot can be triggered for a win anywhere within the range for progressive jackpot). In some example embodiments, players that enter the progressive jackpot at the reset point for the jackpot contribute more of the coin-in to the progressive jackpot than for wagering game plays that the top end of the range for the progressive jackpot. Therefore, these early entries near the reset point of the progressive jackpot having a greater chance of triggering the win because the wagering game play is progressing the jackpot further to the top of its range. For example, if the progressive jackpot is at or near its reset point, 50% of the bet for the wagering game play would be contributed to the progressive jackpot. If the progressive jackpot is at or near the halfway point, 30% of the bet for the wagering game play would be contributed to the progressive jackpot. If the progressive jackpot is at or near the three-quarter point, 20% of the bet for the wagering game play would be contributed to the progressive jackpot, etc. Accordingly, the expected value across the players in the progressive jackpot is evened out as the expected value for the late entry players is pushed back to the early entry players.

In some example embodiments, a player can be presented with a menu of events that can be a participant of. In particular, the event module 108 can transmit a list of upcoming events to the player (instead of a single event invite). For example, after a player logs into their player account at a wagering game machine, a menu with a list of upcoming events can be presented to the player. The added value wagering game activity can be an event wherein the top player receives a prize. For example, the player with the most winnings for the time period for the event is awarded a prize. The prize can include real world product and services (e.g., an automobile), additional free wagering game play (e.g., 50 extra free spins), etc.

While described such that all wagering game players received an event invite, in some example embodiments only one or some wagering game players receive the event invite 160. To illustrate, FIG. 2 depicts the system of FIG. 1, wherein only players wagering at a wagering game machine at a wagering game establishments are invited to participate in the event, according to some example embodiments.

In the example of FIG. 2, the event module 106 transmits the event invite notification 160 (shown as a circle A in FIG. 2) to only the wagering game machine 108 and the wagering game machine 110. For example, the event can include an added value activity that includes a progressive jackpot, wherein the wagering game machines 108-110 are a part of a same bank of machines in the wagering game establishment. The event module 106 can configure the event to have a participatory requirement (e.g., all players wagering at the wagering game machines 108-110 are required to participate). In this example, the wagering game player 130 receives the event invite notification 160 at the wagering game machine 108 from the event module 106 through the network 150 and the network 152. Also, the wagering game player 130 receives the event invite notification 160 at the wagering game machine 110 from the event module 106 through the network 150 and the network 152.

In this example, all of the wagering game players have elected to participate—shown as transmission of event acceptance 162 (shown as a circle B in FIG. 1) from the wagering game machine 108-110 back to the wagering game server 104. In particular, the wagering game player 130 has accepted to participate in the event from the wagering game machine 100, and the wagering game player 132 has accepted to participate in the event from the wagering game machine 110.

FIG. 3 depicts the system of FIG. 1, wherein only one player is invited to participate in the event, according to some example embodiments. In the example of FIG. 3, the event module 106 transmits the event invite notification 160 (shown as a circle A in FIG. 2) to a single wagering game player—the wagering game player 138. In particular, the event module 106 transmits the event invite notification 160 to the mobile device 116 for the wagering game player 138. For example, the wagering game player can be invited to pre-pay prior to arrival at the wagering game establishment 102 for an event that provides an added value activity wherein the participating players are allowed to play at a blackjack table with $5 minimum bet. The event invite notification 160 can be sent as an email, text message, telephone call, etc.

In this example, the wagering game player 138 has elected to participate—shown as transmission of event acceptance 162 (shown as a circle B in FIG. 1) from the mobile device 116 back to the wagering game server 104. In response, the event module 106 can transmit an authorization for the event to the mobile device 116, one of the player accounts for the wagering game player 138, etc. The authorization can be a ticket that can be printed out or shown on the display of the mobile device 116. Personnel at the wagering game establishment 102 can then allow the wagering game player 138 to play at a blackjack table with $5 minimum bet.

There can be various eligibility requirements for players that are invited to an event. The event module 106 can then determine which wagering game players receives an event invite based on these eligibility requirements. For example, players that spend X number of dollars for a given time period would be eligible to participate. In some example embodiments, only the players that are playing a specific wagering game are eligible. For example, for a wagering game establishment, only the players that are logged into their account at a wagering game machine of a bank of wagering game machines are eligible for participating in an activity. Also, a certain number of the eligible players are required to participate in the event to activate. For example, all players at a bank of wagering game machines can be required to participate in order to activate the event. In some example embodiments, players are required to pay a certain monetary amount to participate. If the number of players required to participate does not exceed the required threshold, the players that have elected to participate can be given the option to pay an additional monetary amount to activate the event (even though the requisite number of players electing to participate was not met).

Eligibility for participating in an event can be based on previous wagering game play of a player. For example, the eligibility can be based on the expected value of the previous wagering games played. In one example, a player becomes eligible if they play a wagering game having an expected value of no more than X % (e.g., 95%) with at least N number (e.g., 50) of spins within a defined time period (e.g. within one-half hour). In some example embodiments, the largest contributors for a given time period within a wagering game establishment within a group of wagering games within the wagering game establishment, etc. can be eligible. For example, the top 10 contributors of coin-in for one hour are eligible. The players may or may not be notified of this eligibility monitoring. Where the players are notified, the players can also track their eligibility. Such a configuration can encourage the player to increase their coin-in during this eligibility period. In some example embodiments, player eligibility requires that the player invite at least one other player to the activity. This invite can be through a direct message between the two accounts; an email, text message, etc. This player eligibility can require that this invited player accept.

### Example Operations

This section describes operations associated with some example embodiments. In the discussion below, the flowcharts will be described with reference to the block diagrams presented above. However, in some example embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some example embodiments, the operations can be performed in series, while in other embodiments, one or more of the operations can be performed in parallel. Moreover, some embodiments can perform less than all the operations shown in any flowchart.

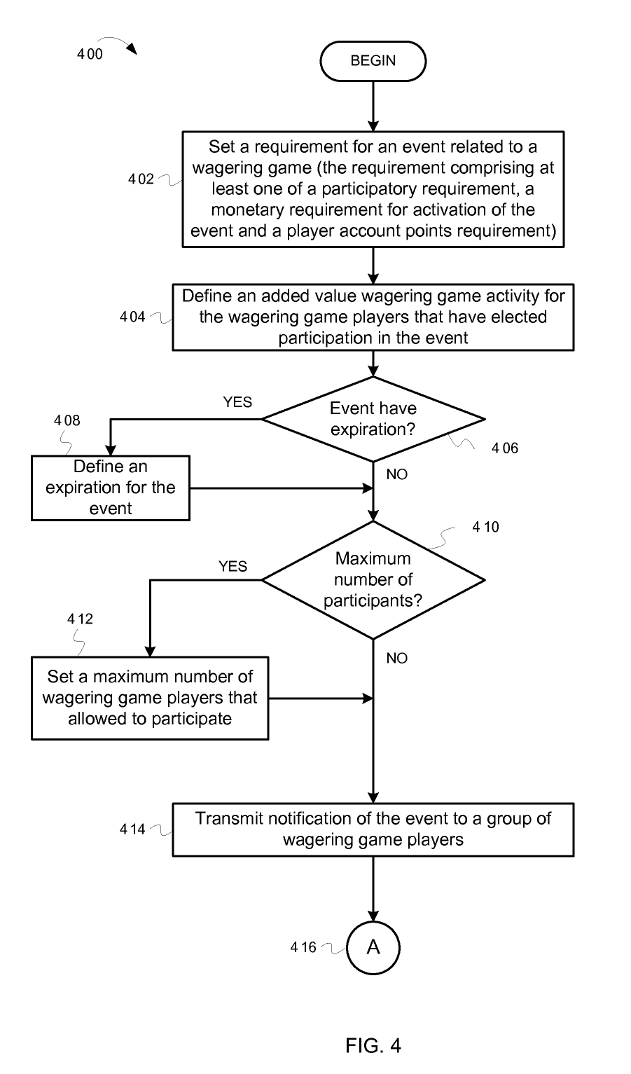

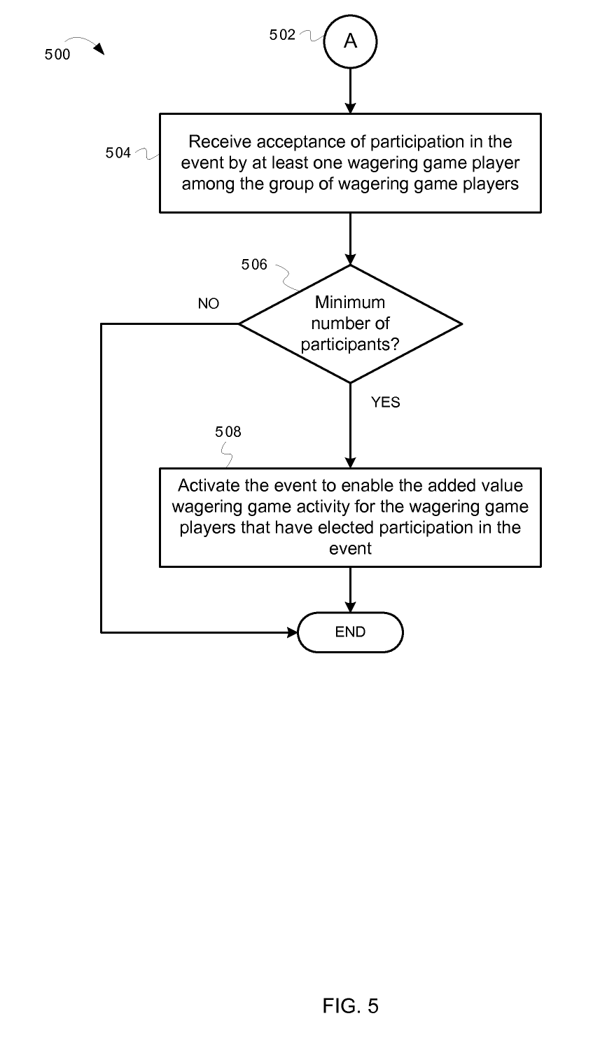

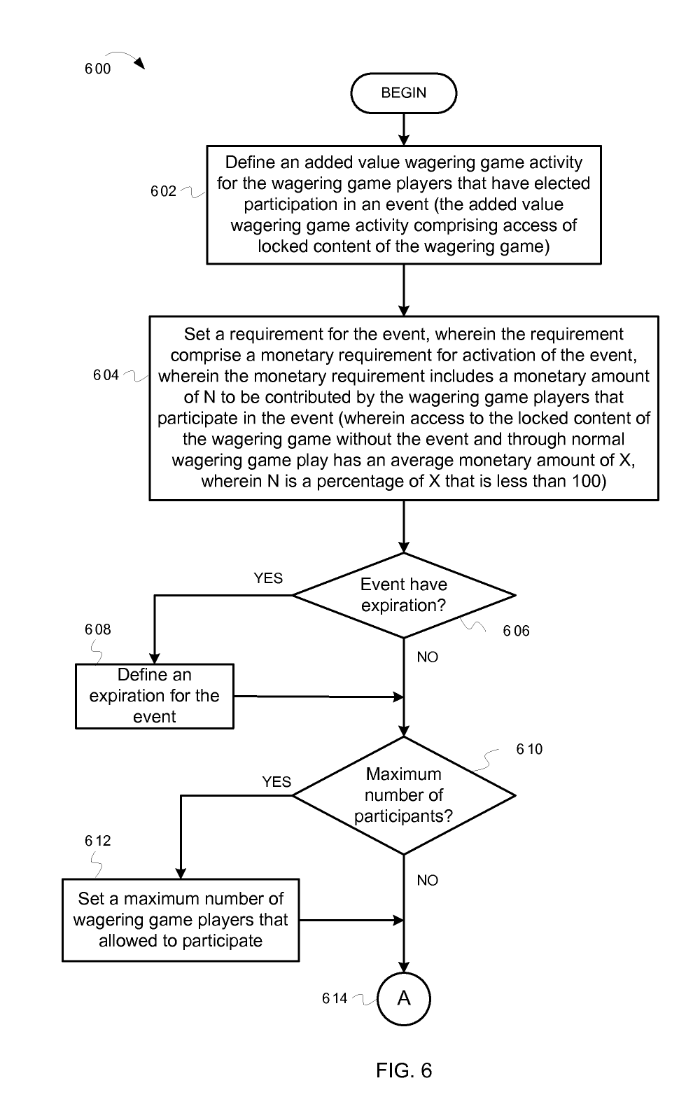

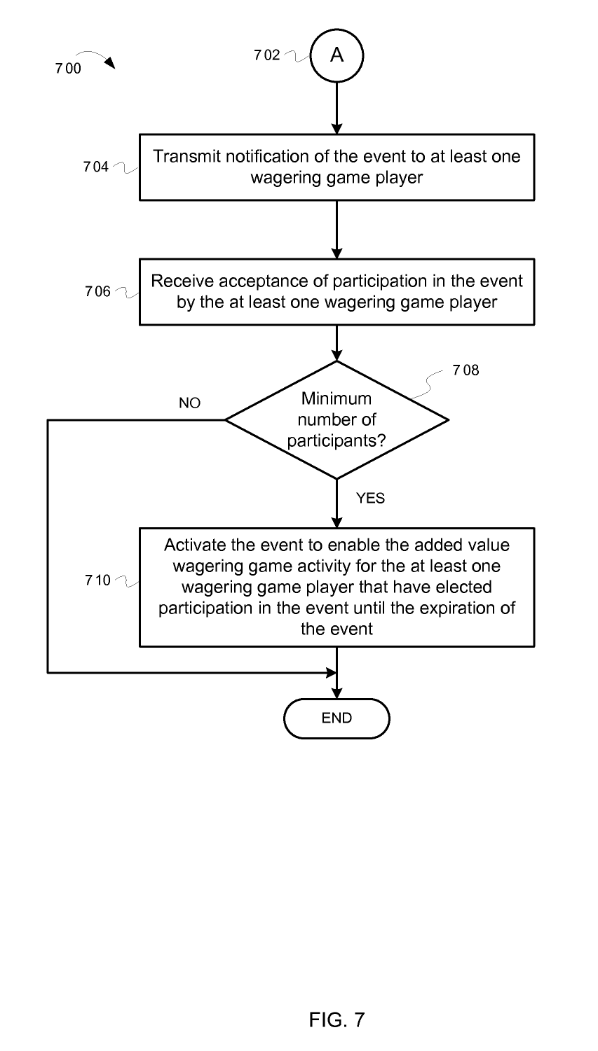

The section will discuss FIGS. 4-7. The discussion of FIGS. 4-5 will describe operations for performing event activation related to wagering game play based on at least one of participation of players, monetary amount and player points. The discussion of FIGS. 6-7 will describe operations for performing event activation related to wagering game play and having accessible content based on discounted monetary amount.

FIGS. 4-5 depict flowcharts for providing activation events related to wagering game play base on at least one of participation of players, monetary amount and player points, according to some example embodiments. The operations of flowcharts 400 and 500 are described in reference to FIGS. 1-3. The operations of the flowchart 400 begin at block 402.

At block 402, the event module 106 sets a requirement for an event related to a wagering game. The requirement can include at least one of a participatory requirement, a monetary requirement for activation of the event and a player account points requirement. With reference to FIGS. 1-3, the event module 106 creates an event that includes at least one of these requirements. For example, the event can be defined to require a threshold (e.g., a participatory threshold, a monetary expenditure threshold, points expenditure threshold, etc.) to trigger an event that provides an added value activity for wagering game play. For example, the player can be required to contribute X amount of money, Y amount of points to participate in the event, while at least N number of players are required to participate to activate the event. Some example embodiments can be applicable to wagering game play of wagering game machines (e.g., slot machines, video poker, etc.) and table games (e.g., blackjack, roulette, poker, etc.). Operations of the flowchart 400 continue at block 404.

At block 404, the event module 106 defines an added value wagering game activity for the wagering game players that have elected participation in the event. Examples of an added value activity for a wagering game (e.g., a slot game) can include unlocking of content, unlocking of an individual bonus, unlocking of a progressive jackpot, increasing of expected values, increasing the payout of the top prize, unlocking a community game, etc. that are part of a wagering game. For example, for a slot game, the added value activity can provide an extra spin where the pay tables are adjusted for better pay out, a bigger top prize, etc. For a bingo game, the added value activity can include a bingo card that has extra numbers that are already covered which are required to be called to win the game. For a table game, these participating players would play from a two-deck shoot instead of a typical six-deck shoot for blackjack. In another example event for a table game, the activity can guarantee a lower minimum bet. In another example event, the table game can be roulette, wherein the activity includes a limited session where multiple (e.g., two) balls instead of one are played. Operations of the flowchart 400 continue at block 406.

At block 406, the event module 106 determines whether the event has an expiration. In particular, the event can be defined to expire after a given time period, after a player wins the top prize, etc. For example, the event can be defined to allow wagering game players to have access to locked content for a two-hour session. If the event has an expiration, operations of the flowchart 400 continue at block 408. Otherwise, operations of the flowchart 400 continue at block 410.

At block 408, the event module 106 defines an expiration for the event. The event module 106 can define the expiration in terms of a time period, after a certain condition is met (e.g., a player wins a certain prize), etc. Operations of the flowchart 400 continue at block 410.

At block 410, the event module 106 determines whether there is a requirement for a maximum number of participants. In particular, the event can be defined to only allow a maximum number of participants to participate in the event. For example, the first 20 wagering game players that elect participation are allowed to participate in the event. If there is a requirement for a maximum number of participants, operations of the flowchart 400 continue at block 412. Otherwise, operations of the flowchart continue at block 414.

At block 412, the event module 106 sets a maximum number of wagering game players that allowed to participate. This maximum number can vary based on the type of event and associated value-added activity. This maximum number can also vary in relation to the expiration of the event. For example, a long term event (six months) can have more participants than a short term event (two hours). Also, this maximum number can vary in relation to the location of the event. For example, if the event is for a bank of wagering game machines, the maximum number of participants is limited to the number of wagering game machines in the bank. Operations of the flowchart 400 continue at block 414.

At block 414, the event module 106 transmits notification of the event to a group of wagering game players. With reference to FIGS. 1-3, the event module 106 transmits the event invite notification 160 to devices accessible to all, some or one wagering game player, depending on how the event is configured. Operations of the flowchart 400 continue at a transition point A 416, which continues at a transition point A 502 of FIG. 5.

Operations continue at flowchart 500, which is now described. The operations of flowchart 500 start at 502. Transition point A 502 is a continuation of operations from flowchart 400 at transition point A 412.

At block 504, the event module 106 receives acceptance of participation in the event by at least one wagering game player among the group of wagering game players. With reference to FIG. 1, the event module 106 receives event acceptance 162 from a number of the wagering game players. In particular, the wagering game player 132 has accepted to participate in the event using the wagering game machine 110; the wagering game player 134 has accepted to participate in the event using the mobile device 112; the wagering game player 140 has accepted to participate in the event using the mobile device 118; the wagering game player 142 has accepted to participate in the event using the computer 120; and the wagering game player 144 has accepted to participate in the event using the computer 122. The operations of the flowchart 500 continue at block 506.

At block 506, the event module 106 determines whether a minimum number of participants have accepted participation in the event. The minimum number of participants can range from one to any number. If the minimum number of participants has accepted participation in the event, the operations of the flowchart 500 continue at block 508. Otherwise, the operations of the flowchart 500 are complete.

At block 508, the event module 106 activates the event to enable the added value wagering game activity for the wagering game players that have elected participation in the event. In particular, after the requirements are met, the event module 106 can activate the event. For example, after N number of wagering game players have elected to participate and contribute X amount of money for participation, the event module 106 can transmit communications to the player accounts and/or machines to activate the event. For example, if the event is to occur at the wagering game machine 108 and the wagering game machine 110, the event module 106 can transmit a message to activate the event to the wagering game machine 108 and the wagering game machine 110 (the message can include an identification of the event, the identification of the players that are participating, the length of the event, etc.). Operations of the flowchart 500 are complete.

Operations for performing event activation related to wagering game play and having accessible content based on discounted monetary amount are now described. In particular, FIGS. 6-7 depict flowcharts for providing event activation related to wagering game play and having accessible content based on discounted monetary amount, according to some example embodiments. The operations of flowcharts 600 and 700 are described in reference to FIGS. 1-3. The operations of the flowchart 600 begin at block 602.

At block 602, the event module 106 defines an added value wagering game activity for the wagering game players that have elected participation in the event. Examples of an added value activity for a wagering game (e.g., a slot game) can include unlocking of content, unlocking of an individual bonus, unlocking of a progressive jackpot, increasing of expected values, increasing the payout of the top prize, unlocking a community game, etc. that are part of a wagering game. For example, for a slot game, the added value activity can provide an extra spin where the pay tables are adjusted for better pay out, a bigger top prize, etc. For a bingo game, the added value activity can include a bingo card that has extra numbers that are already covered which are required to be called to win the game. For a table game, these participating players would play from a two-deck shoot instead of a typical six-deck shoot for blackjack. In another example event for a table game, the activity can guarantee a lower minimum bet. In another example event, the table game can be roulette, wherein the activity includes a limited session where multiple (e.g., two) balls instead of one are played. Operations of the flowchart 600 continue at block 604.

At block 604, the event module 106 sets a requirement for the event, wherein the requirement comprise a monetary requirement for activation of the event, wherein the monetary requirement includes a monetary amount of N to be contributed by the wagering game players that participate in the event (wherein access to the locked content of the wagering game without the event and through normal wagering game play has an average monetary amount of X, wherein N is a percentage of X that is less than 100). In particular, the event module 106 can determine the cost to a typical player for unlocking this content, bonuses, etc. during normal wagering game play. For example, assume it typically costs a player $150 to unlock a given episode in an episodic wagering game. As part of the notification of the activity, the player can be notified of this monetary amount. For example, as part of the notification to encourage a player to participate in an activity, the event module 106 can notify the player that they can unlock certain content (which typically costs $150 through normal wagering game play) for only $75. There can be a limited number of players that can participate. Also, the players can be notified while logged onto their player account at the wagering game establishment or wagering game website, through email, text message, voice call, etc. For example, the players are notified that they can participate in this event wherein they are allowed access to this content for one two-hour session that can be used at their conveniences over the next two weeks. Alternatively, the players who are logged into their player accounts can be required to participate in this event immediately. Such embodiments that unlock certain content gives the players a “taste” of the unlocked content to thereby incentivize them to play the wagering game through normal wagering game play to unlock the content after the activity is complete. Operations of the flowchart 600 continue at block 606.

At block 606, the event module 106 determines whether the event has an expiration. In particular, the event can be defined to expire after a given time period, after a player wins the top prize, etc. For example, the event can be defined to allow wagering game players to have access to locked content for a two-hour session. If the event has an expiration, operations of the flowchart 600 continue at block 608. Otherwise, operations of the flowchart 600 continue at block 610.

At block 608, the event module 106 defines an expiration for the event. The event module 106 can define the expiration in terms of a time period, after a certain condition is met (e.g., a player wins a certain prize), etc. Operations of the flowchart 600 continue at block 610.

At block 610, the event module 106 determines whether there is a requirement for a maximum number of participants. In particular, the event can be defined to only allow a maximum number of participants to participate in the event. For example, the first 20 wagering game players that elect participation are allowed to participate in the event. If there is a requirement for a maximum number of participants, operations of the flowchart 600 continue at block 612. Otherwise, operations 600 of the flowchart continue at a transition point A 614, which continues at a transition point A 702 of FIG. 7.

At block 612, the event module 106 sets a maximum number of wagering game players that allowed to participate. This maximum number can vary based on the type of event and associated value-added activity. This maximum number can also vary in relation to the expiration of the event. For example, a long term event (six months) can have more participants than a short term event (two hours). Also, this maximum number can vary in relation to the location of the event. For example, if the event is for a bank of wagering game machines, the maximum number of participants is limited to the number of wagering game machines in the bank. Operations of the flowchart 600 continue at the transition point A 614, which continues at the transition point A 702 of FIG. 7.

Operations continue at flowchart 700, which is now described. The operations of flowchart 700 start at 702. The transition point A 702 is a continuation of operations from flowchart 600 at transition point A 614.

At block 704, the event module 106 transmits notification of the event to a group of wagering game players. With reference to FIGS. 1-3, the event module 106 transmits the event invite notification 160 to devices accessible to all, some or one wagering game player, depending on how the event is configured. Operations of the flowchart 700 continue at block 706.

At block 706, the event module 106 receives acceptance of participation in the event by at least one wagering game player among the group of wagering game players. With reference to FIG. 1, the event module 106 receives event acceptance 162 from a number of the wagering game players. In particular, the wagering game player 132 has accepted to participate in the event using the wagering game machine 110; the wagering game player 134 has accepted to participate in the event using the mobile device 112; the wagering game player 140 has accepted to participate in the event using the mobile device 118; the wagering game player 142 has accepted to participate in the event using the computer 120; and the wagering game player 144 has accepted to participate in the event using the computer 122. Operations of the flowchart 700 continue at block 708.

At block 708, the event module 106 determines whether a minimum number of participants have accepted participation in the event. The minimum number of participants can range from one to any number. If the minimum number of participants has accepted participation in the event, the operations of the flowchart 700 continue at block 710. Otherwise, the operations of the flowchart 700 are complete.

At block 710, the event module 106 activates the event to enable the added value wagering game activity for the wagering game players that have elected participation in the event. In particular, after the requirements are met, the event module 106 can activate the event. For example, after N number of wagering game players have elected to participate and contribute X amount of money for participation, the event module 106 can transmit communications to the player accounts and/or machines to activate the event. For example, if the event is to occur at the wagering game machine 108 and the wagering game machine 110, the event module 106 can transmit a message to activate the event to the wagering game machine 108 and the wagering game machine 110 (the message can include an identification of the event, the identification of the players that are participating, the length of the event, etc.). Operations of the flowchart 700 are complete.

Wagering Game Machine Architecture and Network Environment

This section describes an example wagering game architecture and network environment of some example embodiments.

### Wagering Game Machine Architecture

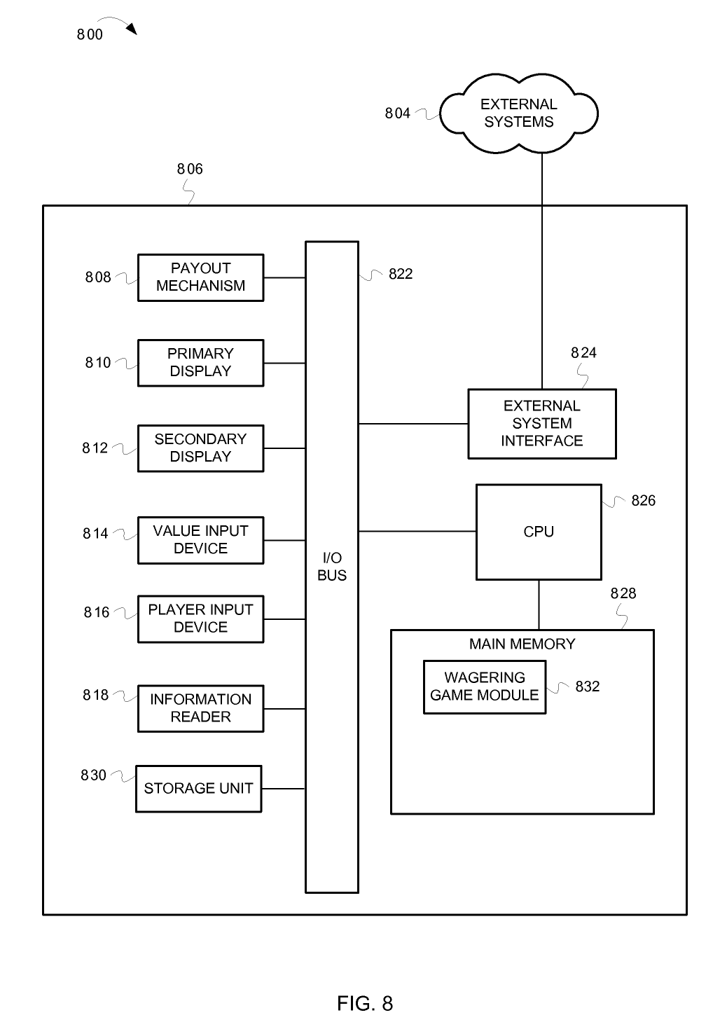

FIG. 8 depicts a block diagram illustrating a wagering game machine architecture, according to some example embodiments. As shown in FIG. 8, the wagering game machine architecture 800 includes a wagering game machine 806, which includes a central processing unit (CPU) 826 connected to main memory 828. The CPU 826 can include any suitable processor, such as an Intel® Pentium processor, Intel® Core 2 Duo processor, AMD Opteron™ processor, or UltraSPARC processor. The main memory 828 includes a wagering game module 832. In some example embodiments, the wagering game module 832 can present wagering games, such as video poker, video blackjack, video slots, video lottery, etc., in whole or part. The wagering game module 832 can also receive a message from the event module 106 to activate an event related to wagering game play (e.g., unlock content). In response, the wagering game module 832 can provide access to such content to wagering game players that are participants in the event.

The CPU 826 is also connected to an input/output (I/O) bus 822, which can include any suitable bus technologies, such as an AGTL+ frontside bus and a PCI backside bus. The I/O bus 822 is connected to a payout mechanism 808, primary display 810, secondary display 812, value input device 814, player input device 816, information reader 818, and storage unit 830. The player input device 816 can include the value input device 814 to the extent the player input device 816 is used to place wagers. The I/O bus 822 is also connected to an external system interface 824, which is connected to external systems 804 (e.g., wagering game networks).

In one embodiment, the wagering game machine 806 can include additional peripheral devices and/or more than one of each component shown in FIG. 8. For example, in one embodiment, the wagering game machine 806 can include multiple external system interfaces 824 and/or multiple CPUs 826. In one embodiment, any of the components can be integrated or subdivided.

Any component of the architecture 800 can include hardware, firmware, and/or machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

While FIG. 8 describes an example wagering game machine architecture, this section continues with a discussion a wagering game network.

### Wagering Game Network

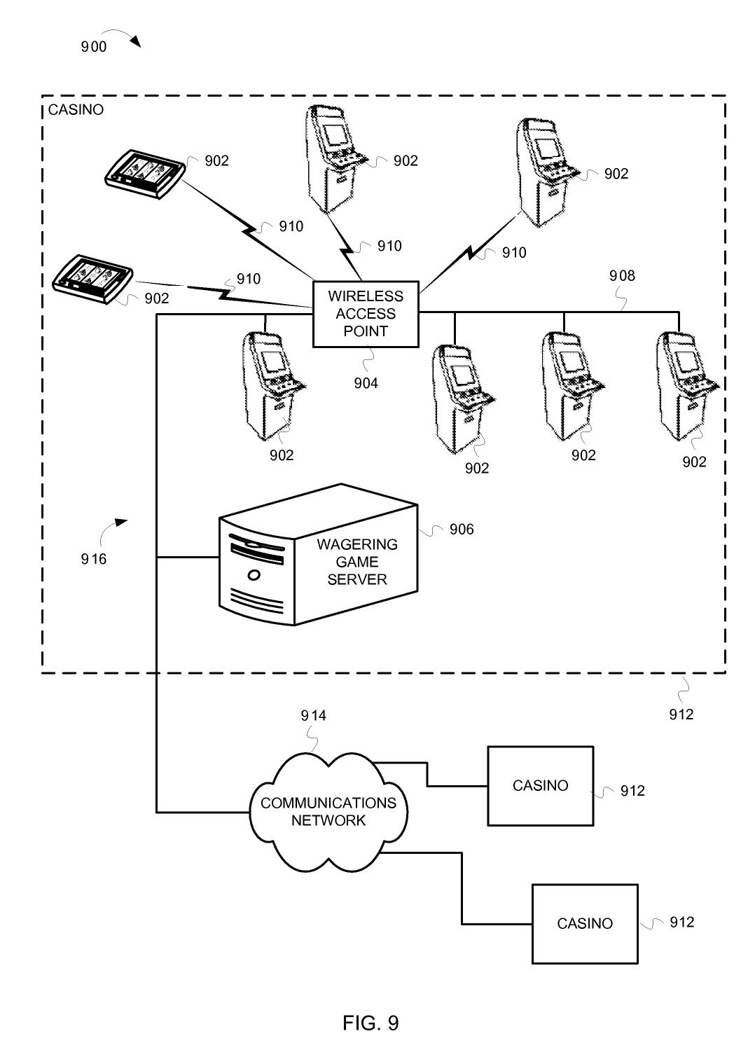

FIG. 9 depicts a block diagram illustrating a wagering game network, according to some example embodiments. As shown in FIG. 9, the wagering game network 900 includes a plurality of casinos 912 connected to a communications network 914.

Each casino 912 includes a local area network 916, which includes an access point 904, a wagering game server 906, and wagering game machines 902. The access point 9304 provides wireless communication links 910 and wired communication links 908. The wired and wireless communication links can employ any suitable connection technology, such as Bluetooth, 802.11, Ethernet, public switched telephone networks, SONET, etc. In some embodiments, the wagering game server 906 can serve wagering games and distribute content to devices located in other casinos 912 or at other locations on the communications network 914. In some example embodiments, the wagering game server 906 can host the event module 106. Alternatively or in addition, the wagering game server 906 can be communicatively coupled to a different server that hosts the event module 106 that is providing the events.

The wagering game machines 902 described herein can take any suitable form, such as floor standing models, handheld mobile units, bartop models, workstation-type console models, etc. Further, the wagering game machines 902 can be primarily dedicated for use in conducting wagering games, or can include non-dedicated devices, such as mobile phones, personal digital assistants, personal computers, etc. In one embodiment, the wagering game network 900 can include other network devices, such as accounting servers, wide area progressive servers, player tracking servers, and/or other devices suitable for use in connection with embodiments of the invention.

In some embodiments, wagering game machines 902 and wagering game servers 906 work together such that a wagering game machine 902 can be operated as a thin, thick, or intermediate client. For example, one or more elements of game play may be controlled by the wagering game machine 902 (client) or the wagering game server 906 (server). Game play elements can include executable game code, lookup tables, configuration files, game outcome, audio or visual representations of the game, game assets or the like. In a thin-client example, the wagering game server 906 can perform functions such as determining game outcome or managing assets, while the wagering game machine 902 can present a graphical representation of such outcome or asset modification to the user (e.g., player). In a thick-client example, the wagering game machines 902 can determine game outcomes and communicate the outcomes to the wagering game server 906 for recording or managing a player's account.

In some embodiments, either the wagering game machines 902 (client) or the wagering game server 906 can provide functionality that is not directly related to game play. For example, account transactions and account rules may be managed centrally (e.g., by the wagering game server 906) or locally (e.g., by the wagering game machine 902). Other functionality not directly related to game play may include power management, presentation of advertising, software or firmware updates, system quality or security checks, etc.

Any of the wagering game network components (e.g., the wagering game machines 902) can include hardware and machine-readable media including instructions for performing the operations described herein.

### Example Wagering Game Machine

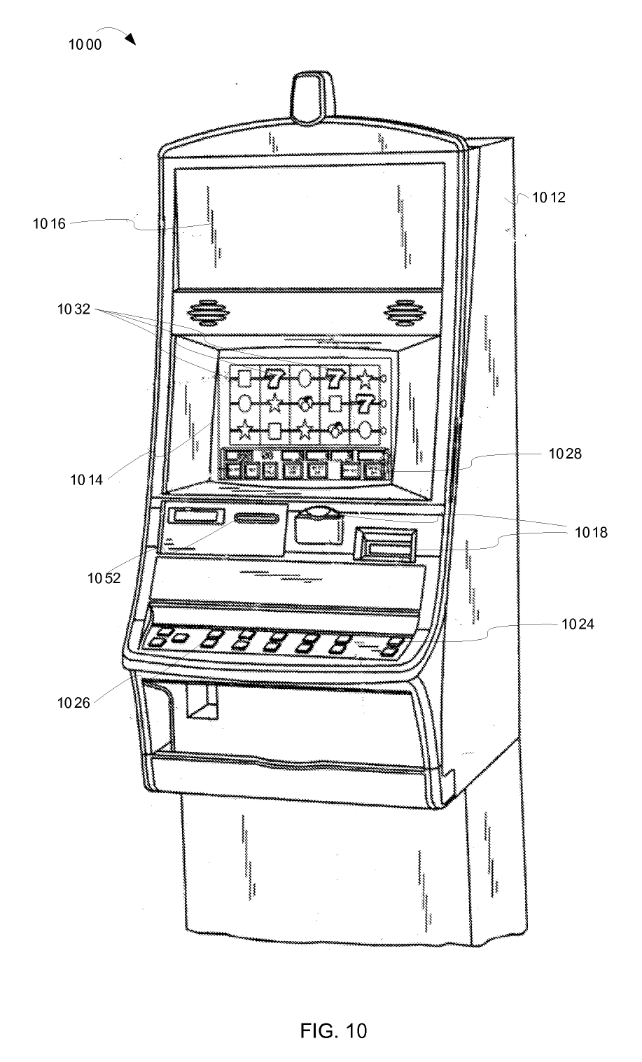

FIG. 10 depicts a perspective view of a wagering game machine, according to some example embodiments. Referring to FIG. 10, a wagering game machine 1000 is used in gaming establishments, such as casinos. According to embodiments, the wagering game machine 1000 can be any type of wagering game machine and can have varying structures and methods of operation. For example, the wagering game machine 1000 can be an electromechanical wagering game machine configured to play mechanical slots, or it can be an electronic wagering game machine configured to play video casino games, such as blackjack, slots, keno, poker, blackjack, roulette, etc.

The wagering game machine 1000 comprises a housing 1012 and includes input devices, including value input devices 1018 and a player input device 1024. For output, the wagering game machine 1000 includes a primary display 1014 for displaying information about a basic wagering game. The primary display 1014 can also display information about a bonus wagering game and a progressive wagering game. The wagering game machine 1000 also includes a secondary display 1016 for displaying wagering game events, wagering game outcomes, and/or signage information. While some components of the wagering game machine 1000 are described herein, numerous other elements can exist and can be used in any number or combination to create varying forms of the wagering game machine 1000.

The value input devices 1018 can take any suitable form and can be located on the front of the housing 1012. The value input devices 1018 can receive currency and/or credits inserted by a player. The value input devices 1018 can include coin acceptors for receiving coin currency and bill acceptors for receiving paper currency. Furthermore, the value input devices 1018 can include ticket readers or barcode scanners for reading information stored on vouchers, cards, or other tangible portable storage devices. The vouchers or cards can authorize access to central accounts, which can transfer money to the wagering game machine 1000.

The player input device 1024 comprises a plurality of push buttons on a button panel 1026 for operating the wagering game machine 1000. In addition, or alternatively, the player input device 1024 can comprise a touch screen 1028 mounted over the primary display 1014 and/or secondary display 1016.

The various components of the wagering game machine 1000 can be connected directly to, or contained within, the housing 1012. Alternatively, some of the wagering game machine's components can be located outside of the housing 1012, while being communicatively coupled with the wagering game machine 1000 using any suitable wired or wireless communication technology.

The operation of the basic wagering game can be displayed to the player on the primary display 1014. The primary display 1014 can also display a bonus game associated with the basic wagering game. The primary display 1014 can include a cathode ray tube (CRT), a high resolution liquid crystal display (LCD), a plasma display, light emitting diodes (LEDs), or any other type of display suitable for use in the wagering game machine 1000. Alternatively, the primary display 1014 can include a number of mechanical reels to display the outcome. In FIG. 10, the wagering game machine 1000 is an “upright” version in which the primary display 1014 is oriented vertically relative to the player. Alternatively, the wagering game machine can be a “slant-top” version in which the primary display 1014 is slanted at about a thirty-degree angle toward the player of the wagering game machine 1000. In yet another embodiment, the wagering game machine 1000 can exhibit any suitable form factor, such as a free standing model, bartop model, mobile handheld model, or workstation console model.

A player begins playing a basic wagering game by making a wager via the value input device 1018. The player can initiate play by using the player input device's buttons or touch screen 1028. The basic game can include arranging a plurality of symbols along a payline 1032, which indicates one or more outcomes of the basic game. Such outcomes can be randomly selected in response to player input. At least one of the outcomes, which can include any variation or combination of symbols, can trigger a bonus game.

In some embodiments, the wagering game machine 1000 can also include an information reader 1052, which can include a card reader, ticket reader, bar code scanner, RFID transceiver, or computer readable storage medium interface. In some embodiments, the information reader 1052 can be used to award complimentary services, restore game assets, track player habits, etc.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A method comprising:
creating an event related to a wagering game, wherein the creating of the event comprises,
setting a requirement for the event, the requirement comprising at least one of a participatory requirement and a monetary requirement for activation of the event, wherein the participatory requirement includes a minimum number of wagering game players required to elect participation in the event, the monetary requirement including a monetary amount to be contributed by the wagering game players that participate in the event;
defining an added value wagering game activity for the wagering game players that have elected participation in the event, the added value wagering game activity comprising at least one of access of locked content of the wagering game, increased expected value for payout from the wagering game, increased value of a jackpot of the wagering game, access to a locked progressive jackpot, and access to locked bonuses;
defining an expiration for the event; and
setting a maximum number of wagering game players that allowed to participate;
transmitting notification of the event to devices accessible by a group of wagering game players, wherein the transmitting comprises posting notification of the event at a player accounts for the group of wagering game players;
receiving acceptance of participation in the event from at least one of the devices; and
responsive to acceptance of participation in the event, activating the event to enable the added value wagering game activity until the expiration of the event.

2. The method of claim 1, wherein defining the expiration for the event comprising defining a time period when the expiration for the event occurs.

3. The method of claim 1, wherein the requirement comprises a player account points requirement that includes a number of player account points to be contributed by the wagering game players that participate in the event.

4. The method of claim 1, wherein creating the event related to the wagering game comprising setting an eligibility requirement for the wagering game players that can participate, wherein the group of wagering game players satisfy the eligibility requirement.

5. The method of claim 1, wherein the minimum number of wagering game players comprises two or more wagering game players.

6. A method comprising:
creating an event related to a wagering game, wherein the creating of the event comprises,
defining an added value wagering game activity for wagering game players that have elected participation in the event, the added value wagering game activity comprising access of locked content of the wagering game;
setting a requirement for the event, the requirement comprising a monetary requirement for activation of the event, wherein the monetary requirement includes an event monetary amount to be contributed by the wagering game players that participate in the event, wherein access to the locked content of the wagering game without the event and through normal wagering game play has an average monetary amount, wherein the event monetary amount is less than the average monetary amount; and
defining an expiration for the event;
transmitting notification of the event to at least one wagering game player, wherein the transmitting comprises posting notification of the event at a player account for the at least one wagering game player;
receiving an indication that the at least one wagering game player has accepted participation in the event by the at least one wagering game player; and
responsive to the indication, activating the event to enable the added value wagering game activity for the at least one wagering game player until the expiration of the event.

7. The method of claim 6, wherein transmitting notification of the event comprising transmitting notification of the event monetary amount to participate in the event and notification of the average monetary amount that is needed to access the locked content of the wagering game without the event and through normal wagering game play.

8. The method of claim 6, wherein creating the event related to the wagering game comprising setting a maximum number of wagering game players that allowed to participate in the event.

9. The method of claim 6, wherein creating the event related to the wagering game comprising setting an eligibility requirement for the wagering game players that can participate, wherein the at least one wagering game player that receives the notification of the event satisfies the eligibility requirement.

10. The method of claim 6, wherein defining the expiration for the event comprising defining a time period when the expiration for the event occurs.

11. One or more machine-readable storage media including instructions which, when executed by one or more processors, cause the one or more processors to perform operations comprising:
create an event related to a wagering game, wherein the operation to create the event comprises,
set a requirement for the event, the requirement comprising at least one of a participatory requirement and a monetary requirement for activation of the event, wherein the participatory requirement includes a minimum number of wagering game players required to elect participation in the event, the monetary requirement including a monetary amount to be contributed by the wagering game players that participate in the event;
define an added value wagering game activity for the wagering game players that have elected participation in the event, the added value wagering game activity comprising at least one of access of locked content of the wagering game, increased expected value for payout from the wagering game, increased value of a jackpot of the wagering game, access to a locked progressive jackpot, and access to locked bonuses;
define an expiration for the event; and
set a maximum number of wagering game players that allowed to participate;
transmit notification of the event to devices accessible by a group of wagering game players, wherein the transmitting comprises posting notification of the event at a player accounts for the group of wagering game players;
receive acceptance of participation in the event from at least one of the devices; and
responsive to acceptance of participation in the event, activate the event to enable the added value wagering game activity until the expiration of the event.

12. The one or more machine-readable storage media of claim 11, wherein the operation to define the expiration for the event comprising an operation to define a time period when the expiration for the event occurs.

13. The one or more machine-readable storage media of claim 11, wherein the requirement comprises a player account points requirement that includes a number of player account points to be contributed by the wagering game players that participate in the event.

14. The one or more machine-readable storage media of claim 11, wherein the operation to create the event related to the wagering game comprises an operation to set an eligibility requirement for the wagering game players that can participate, wherein the group of wagering game players satisfy the eligibility requirement.

15. The one or more machine-readable storage media of claim 11, wherein the minimum number of wagering game players comprises two or more wagering game players.

16. An apparatus comprising:
a processor;
an event module executable on the processor, the event module configured to,
create an event related to a wagering game, wherein as part of creation of the event the event module is configured to,
define an added value wagering game activity for wagering game players that have elected participation in the event, the added value wagering game activity comprising access of locked content of the wagering game;
set a requirement for the event, the requirement comprising a monetary requirement for activation of the event, wherein the monetary requirement includes an event monetary amount to be contributed by the wagering game players that participate in the event, wherein access to the locked content of the wagering game without the event and through normal wagering game play has an average monetary amount, wherein the event monetary amount is less than the average monetary amount; and
define an expiration for the event;
transmit notification of the event to at least one wagering game player, wherein the transmitting comprises posting notification of the event at a player account for the at least one wagering game player;
receive an indication that the at least one wagering game player has accepted participation in the event by the at least one wagering game player; and
responsive to the indication, activate the event to enable the added value wagering game activity for the at least one wagering game player until the expiration of the event.

17. The apparatus of claim 16, wherein as part of transmission of notification of the event the event module is configured to transmit notification of the event monetary amount to participate in the event and notification of the average monetary amount that is needed to access the locked content of the wagering game without the event and through normal wagering game play.

18. The apparatus of claim 16, wherein as part of creation of the event related to the wagering game the event module is configured to set a maximum number of wagering game players that allowed to participate in the event.

19. The apparatus of claim 16, wherein as part of creation of the event related to the wagering game the event module is configured to set an eligibility requirement for the wagering game players that can participate, wherein the at least one wagering game player that receives the notification of the event satisfies the eligibility requirement.

20. The apparatus of claim 16, wherein as part of defining the expiration for the event the event module is configured to define a time period when the expiration for the event occurs.

21. An apparatus comprising:
means for creating an event related to a wagering game, wherein the means for creating of the event comprises,
means for setting a requirement for the event, the requirement comprising at least one of a participatory requirement and a monetary requirement for activation of the event, wherein the participatory requirement includes a minimum number of wagering game players required to elect participation in the event, the monetary requirement including a monetary amount to be contributed by the wagering game players that participate in the event;
means for defining an added value wagering game activity for the wagering game players that have elected participation in the event, the added value wagering game activity comprising at least one of access of locked content of the wagering game, increased expected value for payout from the wagering game, increased value of a jackpot of the wagering game, access to a locked progressive jackpot, and access to locked bonuses;
means for defining an expiration for the event; and
means for setting a maximum number of wagering game players that allowed to participate;
means for transmitting notification of the event to devices accessible by a group of wagering game players, wherein the transmitting comprises posting notification of the event at a player accounts for the group of wagering game players;
means for receiving acceptance of participation in the event from at least one of the devices; and
responsive to acceptance of participation in the event, means for activating the event to enable the added value wagering game activity until the expiration of the event.

22. The apparatus of claim 21, wherein the means for defining the expiration for the event comprising means for defining a time period when the expiration for the event occurs.

23. The apparatus of claim 21, wherein the requirement comprises a player account points requirement that includes a number of player account points to be contributed by the wagering game players that participate in the event.

24. The apparatus of claim 21, wherein the means for creating the event related to the wagering game comprising means for setting an eligibility requirement for the wagering game players that can participate, wherein the group of wagering game players satisfies the eligibility requirement.

25. The apparatus of claim 21, wherein the minimum number of wagering game players comprises two or more wagering game players.
